(19) United States
(12) Patent Application Publication
(10) Pub. No.: US 2019/0204004 A1
(43) Pub. Date: Jul. 4, 2019

(54) AIRCRAFT GALLEY

(71) Applicant: AIRBUS OPERATIONS GMBH, Hamburg (DE)

(72) Inventors: Torsten GIENKE, Harsefeld (DE); Norman KOSCHINSKI, Hamburg (DE); Rainer STETTNISCH, Jork (DE)

(21) Appl. No.: 16/227,349

(22) Filed: Dec. 20, 2018

(30) Foreign Application Priority Data
Dec. 20, 2017 (DE) 10 2017 130 722.2

(51) Int. Cl. F25D 21/14; B64D 13/08; B64D 11/04; B64D 11/00

(52) U.S. Cl. CPC F25D 21/14; B64D 13/08; B64D 2013/0629; B64D 11/0007; B64D 11/04

(57) ABSTRACT

An aircraft galley with a main body formed with walls and a cover plate which form a stowage space for catering containers and have trolley berths arranged next to one another. The stowage space is configured as a cooling chamber, and at least one cooling apparatus introduces cooling air into the stowage space via cooling air outlets in the upper region of the catering containers and extracts heated cooling air via return air inlets in the lower region of the catering containers. A drip pan is substantially perpendicularly below the cooling apparatus, which drip pan has, in the edge region of at least one side, a transition portion to a seal, and a collecting portion. This advantageously achieves a situation where the condensed water is collected and discharged, and accumulations of water are avoided on the floor of the galley in the working area of the flight attendants.

### CROSS-REFERENCE TO RELATED APPLICATION

This application claims priority to German Patent Application No. 10 2017 130 722.2 filed Dec. 20, 2017, the entire disclosure of which is incorporated by reference herein.

### TECHNICAL FIELD

The disclosure herein relates to an aircraft galley having a stowage space for catering containers, the stowage space being configured as a cooling chamber.

### BACKGROUND

Aircraft galleys are usually integrated into aircraft, which aircraft galleys have a stowage space for catering containers and also individual compartments for receiving appliances, such as coffee machines, ovens and/or microwave appliances, for example. Furthermore, the catering containers are usually configured as trolleys (what are known as aircraft catering trolleys) which are provided with rollers and can be pushed into the stowage space of the galley for storage.

Foodstuffs and beverages which are provided for supplying the aircraft passengers during a flight are stored in the trolleys or correspondingly equipped storage cupboards in the region of the galleys, until they are distributed to the aircraft passengers by the cabin crew. In order to keep the foodstuffs and beverages cool until consumption, it is known to cool the trolleys or the storage cupboards which are provided in the region of the galleys of the aircraft.

It is known, for example, from EP 2 750 971 B1 to cool trolleys which are positioned in the region of the galleys of the aircraft for storing foodstuffs which are to be stored at a cool temperature with the aid of autonomous cooling apparatuses which operate with cold air as a cooling medium and are equipped in each case with a dedicated compression refrigeration machine (air chiller).

As an alternative to this, for example, DE 43 40 317 C2 describes a central compression refrigeration machine, the refrigerating performance of which is distributed via a coolant liquid circuit to cooling stations which are arranged in the region of the aircraft galleys. The cooling stations which are supplied with cooling energy by the central refrigeration machine output the the cooling energy, via cooling air circuits which are coupled thermally to the liquid coolant circuit of the central refrigeration machine via corresponding heat exchangers, to trolleys which are positioned in the region of the galleys of the aircraft for storing foodstuffs which are to be stored at a cool temperature.

Regardless of whether the cooling energy which is required for cooling the foodstuffs which are to be stored at a cool temperature is provided by an autonomously operating air chiller or a central liquid cooling system of the aircraft, different systems for feeding cooling air to the foodstuffs to be cooled can be used. Widespread air-over systems comprise a thermally insulated cooling chamber which is sealed against leaks and is flowed through by cooling air which is provided by the air chiller or the central liquid cooling system. The trolleys which are loaded with the foodstuffs to be cooled can be pushed into the cooling chambers which are configured as a trolley stowage space. Trolleys which are suitable for use in an air-over system are themselves not insulated, but rather have air openings which enable an unimpeded circulation of cooling air from the cooling chamber through the trolleys and, as a result, over the foodstuffs to be cooled which are received in the trolleys. In order to avoid cooling energy losses, the stowage spaces of the trolleys have to be sealed against cooling air leaks. This is usually realized by way of brush seals, elastomer seals, lamellar seals or squeeze-type elastomer seals.

A sealing means of this type also leads, however, to the not insignificant circumstance that condensed water is formed on cold surfaces in the cooled stowage space of the trolleys, which water drips onto the floor, and accumulations of water are produced in the region of the galley. Causes for condensation within the stowage space are, for example, the use of additional ice on the trolleys, frequent opening of the stowage space doors while the cooling system is running, and condensation on the cooling unit.

Condensed water can therefore occur, in particular, on the floor in the opening region of the trolley stowage space, that is to say in the region of the working area which is utilized by the cabin crew, and can be disruptive there for the flight attendants.

### SUMMARY

It is an object of the disclosure herein to provide a galley which discharges the condensed water for the cooled stowage space of the trolleys and avoids accumulations of water on the floor of the galley in the working area of the cabin crew.

The object is achieved by the subject matter disclosed herein.

In accordance with one exemplary embodiment of the disclosure herein, an aircraft galley having a main body is specified, the main body being formed at least with walls and a cover plate which form a stowage space for catering containers and have a plurality of trolley berths which are arranged next to one another. The stowage space is configured as a cooling chamber, and at least one cooling apparatus is provided which introduces cooling air into the stowage space via cooling air outlets in the upper region of the catering containers and extracts heated cooling air via return air inlets in the lower region of the catering containers. According to the disclosure herein, a drip pan is arranged substantially perpendicularly below the cooling apparatus, which drip pan has, in the edge region of at least one side, a transition portion to a seal, and a collecting portion. The collecting portion is preferably configured as a trough and prevents the collected condensate from running out.

In this way, the condensed water which is formed on cold surfaces is collected in the cooled stowage space of the trolleys, which condensed water would otherwise drip onto the aircraft floor, and accumulations of water can be avoided in the region of the working area of the galley. In particular, the floor can be kept dry in the opening region of the trolley stowage space at the bottom. The configuration of the edge region of the drip pan with a sealing edge makes it possible that cooling energy losses are avoided in the cooled stowage space.

The design of the further edge region of the drip pan as a floor boundary portion provides an optimized transition to the floor, which transition at the same time determines the height and slope of the collecting portion by way of the edge which is configured.

In order to avoid collected condensed water running out of the collecting portion, the collecting portion is provided with drainage surfaces and with an edge bead. The the edge bead is preferably provided at least on three sides of the drip pan or else in a completely circumferential manner.

In one embodiment, the drip pan has an outflow opening which makes defined drainage of the condensed water possible. The the outflow opening is preferably configured as a bore or outflow connector. The drip pan can be fastened by way of suitable fastening of the drip trough to the water outlet, for example to the outflow connector. Further possibilities are the direct fixing on the aircraft floor and/or also sealing with silicone around the outflow plug which at the same time fulfils a fixing function. The fixing of the drip pan in the stowage space can also take place as an alternative to or in combination with customarily known releasable fastening methods by way of corresponding capabilities of a skilled person in the art.

The outflow bore or the outflow connector is advantageously connected to an outflow hose which establishes a connection to an aircraft drainage system. The drainage can therefore take place, for example, via a drain mast of the aircraft or else to a collecting container or to the aircraft waste water system. For this purpose, the outflow hose can advantageously be guided outside the passenger cabin through a floor panel of the aircraft floor. The drainage can advantageously take place via systems in the region below the aircraft passenger cabin.

In the aircraft galley according to the disclosure herein, the cooling apparatus, the cooling air outlets and return air inlets are arranged in the region of the rear wall.

In order to make optimum collecting of the condensed water possible, the width of the drip pan is adapted substantially to the width of a trolley berth. The width therefore corresponds to the width of the compartment in the stowage space of the galley, which compartment is provided for a trolley or two half-sized trolleys.

Furthermore, the depth of the drip pan can be adapted to the trolley geometries and to dimensions and positions of the transport rollers on the trolleys. The size and positioning of the drip pan in the stowage space is designed in such a way that the trolley movement paths are not impeded. The positioning of the drip pan advantageously results in the floor clearance between the rearward wall of the stowage space and the rear wheels of the catering container.

In order to minimize the losses of the necessary cooling energy for cooling the trolleys and to avoid leaks, the seals are arranged in the region of the aircraft flooring via bars on the walls of the galley. The transition portion to the seal can therefore be positioned in an optimum manner in the region of the drip pan, in particular.

A passenger aircraft having an advantageous galley according to the disclosure herein is likewise specified.

Further advantageous embodiments and developments can be gathered from the disclosure including drawings and description herein.

### BRIEF DESCRIPTION OF THE DRAWINGS

In the following text, preferred exemplary embodiments of the disclosure herein are described with reference to the figures. The same reference numerals are used for the same or similar elements.

The illustrations in the figures are diagrammatic and are not to scale.

FIG. 1 shows a diagrammatic illustration of a cabin monument with a stowage space for catering containers in a front view.

FIG. 2 shows a side view of a stowage space of a galley with a catering container in a pushed-in position.

FIG. 3 shows a perspective view of a detail of the stowage space of a galley.

FIG. 4 shows a perspective partial illustration of the drip pan according to the disclosure herein in the stowage space of the galley.

FIG. 5 shows the drip pan in a perspective view.

FIG. 6 shows the drip pan in a side view.

FIG. 7 shows a passenger aircraft, in which a galley according to the disclosure herein is arranged.

### DETAILED DESCRIPTION

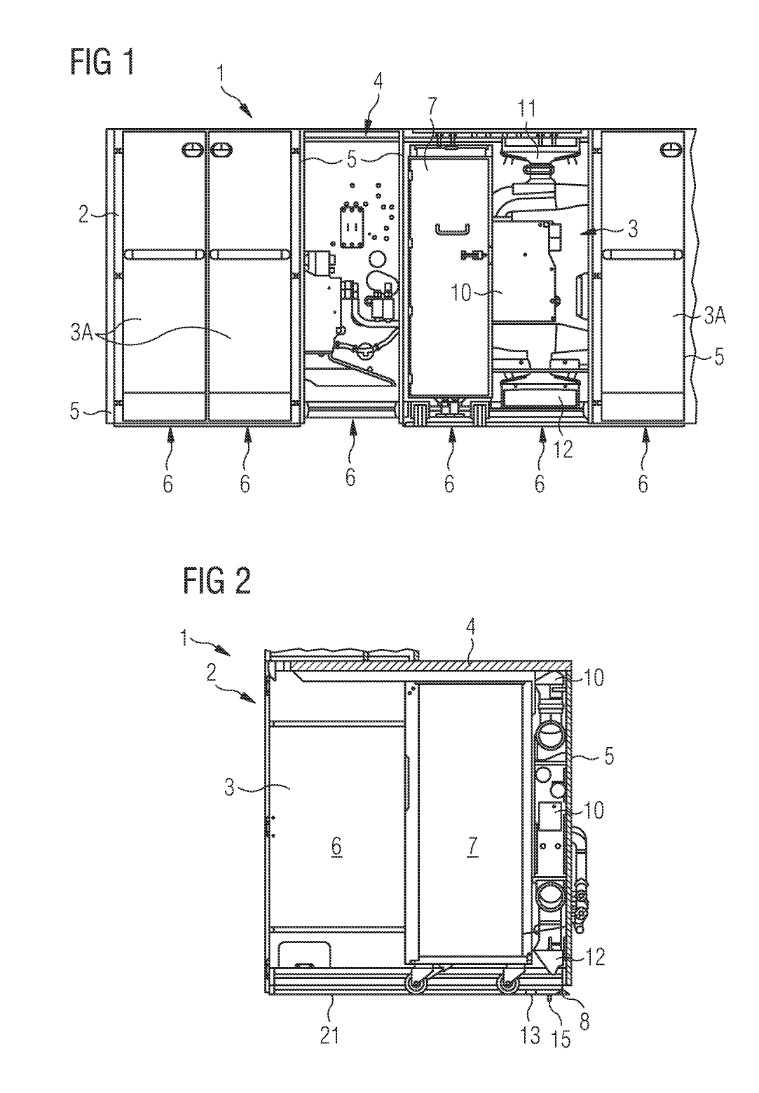

FIG. 1 shows an aircraft cabin monument 1 with its lower main body 2 in a view from the front. As can be seen, the cabin monument 1 is configured as a galley. For this purpose, the lower main body 2 of the cabin monument 1 is provided with a stowage space 3 for catering containers 7, what are known as trolleys. Side walls 5 form the lateral and inner boundaries, in order to realize trolley berths 6. A cover plate 4 forms the upper limit and preferably forms a working surface of the kitchen. The stowage space 3 is configured as a cooling chamber and comprises a thermally insulated space which is sealed against leaks. For this purpose, doors 3A to the trolley berths 6 are provided in each case. Furthermore, the walls 4 and 5 are preferably provided with insulation, and seals 8 are provided between the side walls 5 and the aircraft floor. The seals 8 can usually be configured as elastomer seals, lamellar seals or squeeze-type elastomer seals. Brush seals can be provided in the region of the doors 3A to the stowage space 3.

The galley 1 likewise has a cooling apparatus 10 which is preferably arranged in the rearward region of the galley 1. This can be seen clearly in the sectional illustration from the side in FIG. 2. The cooling apparatus 10 here is a cooling unit which cools air as a cooling medium to the required temperature and conducts the cooling air into the stowage space 3 via a plurality of cooling air outlets 11 and allows it to flow over the catering containers 7. The heated cooling air is removed from the stowage space 3 again via a plurality of return air inlets 12. A cooling principle of this type is called “air-over cooling”. The side view in FIG. 2 shows what is known as a half-sized trolley 7 which has been pushed into the stowage space 3 to such an extent that it is positioned with its rear wall on the cooling apparatus 10. This design of the trolley 7 makes it possible that a further half-sized trolley can be positioned in the front region of the trolley berth 6. The catering containers (trolleys) 7 are not insulated themselves for a cooling system of this type, but rather are flowed around and possibly flowed through by the cooling air, and the foodstuffs and beverages which are stored in the catering container 7 are therefore cooled.

In the cooled stowage space 3, condensed water can form on the surfaces on account of the cold cooling air. Condensed water is formed, for example, if warmer water-containing air passes into the stowage space 3. Furthermore, it occurs during starting of the cooling system; at that point, the air in the stowage space 3 is then cooled and condenses. This product of the condensation of water from the air which is also called condensate can drip onto the aircraft floor. The the condensed water occurs, in particular, at the bottom below the cooling apparatus 10 as a result of condensate which drips down, and can be collected by way of a drip pan 13 in accordance with the disclosure herein. Accumulations of water can therefore be avoided in the region of the galley 1 in the bottom region of the trolley stowage space 3. This advantageously achieves a situation where no moisture occurs and no water flows over the floor in the region of the working area which is utilized by the cabin crew.

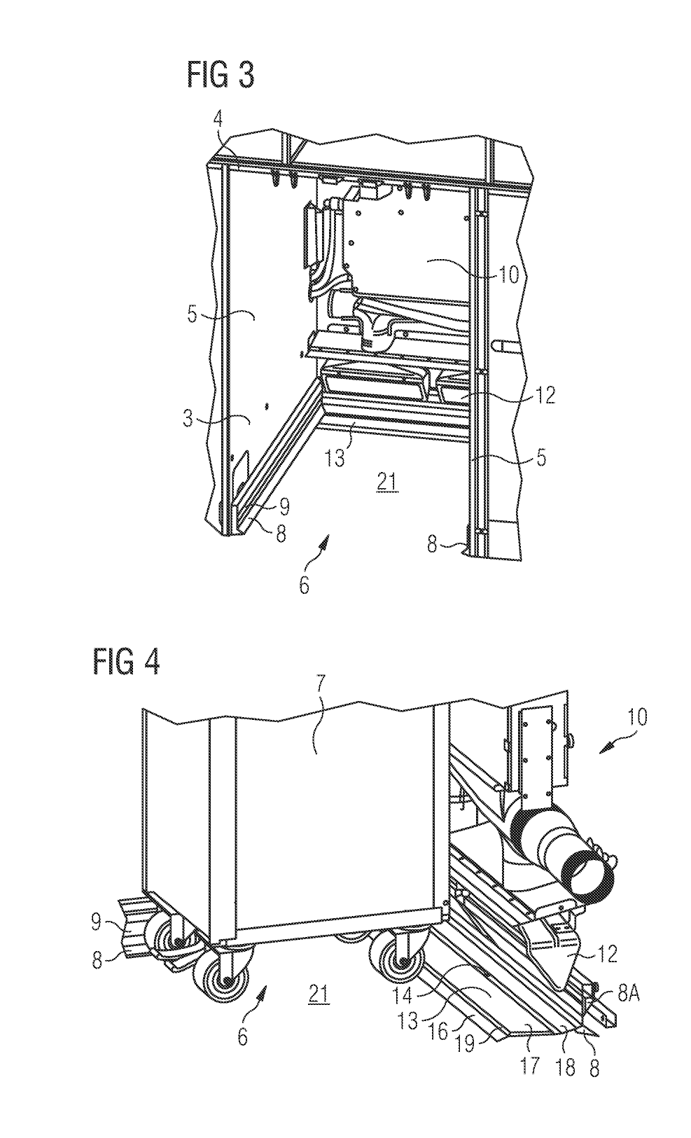

FIG. 3 shows a perspective view of a detail of the stowage space 3 of a galley 1. The the stowage space which is shown has, as a trolley berth 6 for a trolley 7, side walls 5 which are sealed with respect to the aircraft floor 21 by way of seals 8. The seals 8 are arranged on bars 9 for simple mounting. The bars 9 serve at the same time as protective bars or covering bars which are fastened to the side walls 5 in such a way that the seals 8 are positioned in a sealing manner with respect to the aircraft floor 21. The seals 8 also run in the rearward region of the galley 1 as a seal between the rear wall and the aircraft floor 21. Details of the cover plate 4 can likewise be seen. The cooling apparatus 10 is arranged in the rearward region of the galley 1. The drip pan 13 is positioned along the rear wall on the aircraft floor 21 below the the cooling apparatus 10.

FIG. 4 shows a perspective partial illustration of the drip pan 13 according to the disclosure herein and its positioning on the aircraft floor 21 in the stowage space 3 of the galley 1. The drip pan 13 corresponds to the width of the trolley compartment 6 and terminates by way of the front edge region with a floor boundary portion 16 to the aircraft floor 21. The depth of the drip pan 13 is selected in such a way that firstly the depth of the cooling apparatus 10 is taken into consideration and secondly positioning of the trolley wheels of the trolley 7 on the trolley berth 6 is not impeded or impaired. In this way, the handling of the catering containers is not restricted. The rear edge region is configured as a transition portion 18 to the rear seal 8. The latter is preferably configured as a continuous edge, in order not to produce any additional cleaning regions or surfaces for cleaning of the seals. The collecting portion 17 forms substantially the drip pan and is surrounded by an edge bead 19. The the edge bead 19 prevents that the collected condensed water can flow out from the pan 13. The drip pan 13 is provided with an outflow opening 14. The the opening is positioned in the lowermost plane of the drip pan 13, in order to achieve unimpeded running out of the condensed water on the basis of the action of gravity. An outflow hose 15 is arranged at the the opening 14 which is preferably configured as a bore or an outflow connector, which outflow hose 15 enables drainage of the condensed water through the aircraft floor 21 to a drainage collecting tank (not shown). It is also possible that an interface to the drainage system which is present in the aircraft is provided via a drain mast or a waste water system. The drip pan 13 can be fastened by way of suitable fastening of the trough to the water outlet, for example to the outflow plug. Further possibilities are the direct fixing on the aircraft floor and/or also sealing with silicone around the pan 13, which sealing at the same time fulfils a fixing function. The fixing of the drip pan 13 in the stowage space 3 can also take place as an alternative to or in combination with customarily known releasable fastening methods by way of corresponding capabilities of a skilled person in the art.

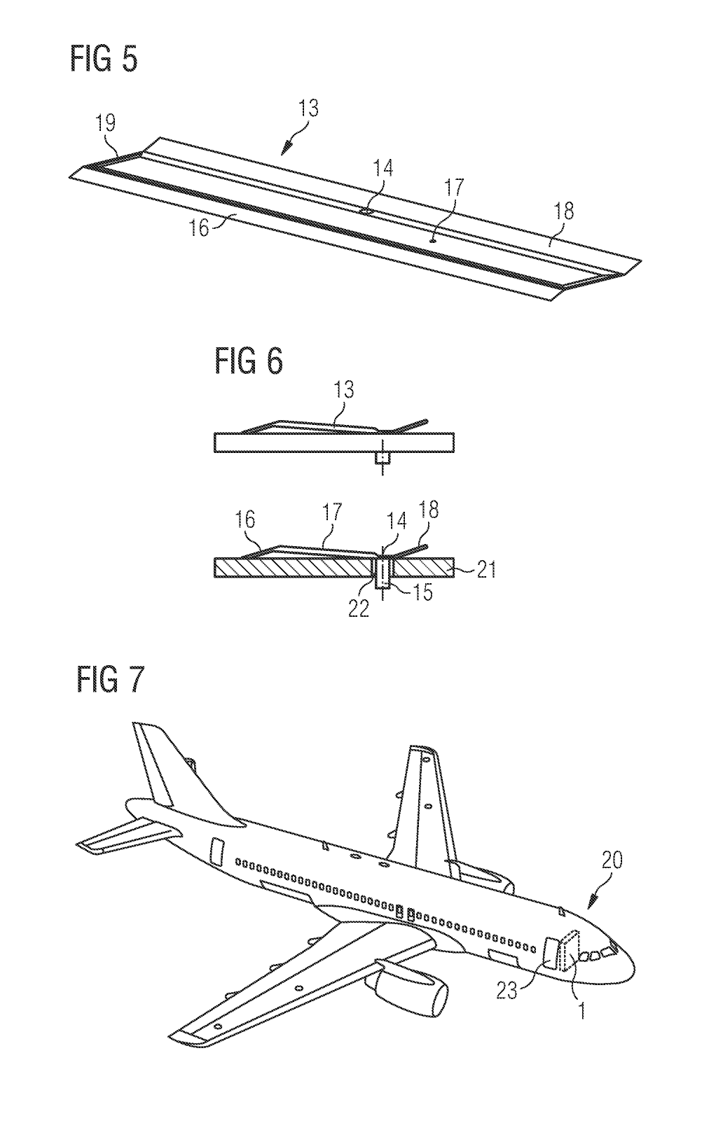

FIG. 5 shows the drip pan 13 as a separate component in a perspective illustration. The profile of the the drip pan 13 and its positioning on the aircraft floor 21 can be seen clearly in the side view in FIG. 6. As has already been mentioned in the description of the figures with respect to FIG. 4, the outflow opening or the outflow connector 14 is connected to a drainage system by an outflow hose 15. For this purpose, an opening 22 is made in the aircraft floor 21, which opening 22 makes it possible to lead through the outflow hose 15. Furthermore, it can be seen clearly in FIG. 6 that the drip pan 13 comprises, as main portion, the collecting portion 17 which is slightly inclined and forms a drainage surface for the collected condensed water to the outflow 14. The floor boundary portion 16 is provided as an edge at the front rim region of the drainage portion 17, which floor boundary portion 16 is seated on the aircraft floor 21 and, by way of its shape and curvature, defines the height and inclination of the collecting portion 17. The rear rim region is configured as an edge or transition portion 18 to the rear seal 8. It can be seen that the edge or the transition portion 18 is bent upwards, in order to realize a sealing and/or dimensionally adapted effect with the rear seal 8. The collecting portion 17 is surrounded by an edge bead 19. The the edge bead 19 prevents that the collected condensed water can flow out from the pan 13 over the pan edge. The outflow of the condensed water from the drip pan 13 takes place via the outflow opening 14 and the outflow hose 15 which is connected to it. Customary connections can be used here. Releasable connections are advantageous, such as screw connections or plug-in connections, for example.

FIG. 7 shows a passenger aircraft 20. Here, a galley 1 according to the disclosure herein is arranged in the passenger cabin, for example in the region of the front access door 23.

Furthermore, it is to be noted that features or steps which have been described with reference to one of the above exemplary embodiments can also be used in combination with other features or steps of other above-described exemplary embodiments. Reference numerals in the claims are not to be considered to be a restriction.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE NUMERALS

1 Cabin monument (galley)
2 Main body/lower part of the galley
3 Stowage space
3A Door
4 Cover plate
5 Side wall
6 Trolley berth
7 Catering container/trolley
8 Seal
9 Bar
10 Cooling apparatus
11 Cooling air outlet
12 Return air inlet
13 Drip pan
14 Outflow opening
15 Outflow hose
16 Floor boundary portion/front edge
17 Collecting portion with drainage surface
18 Transition portion to the seal/rear edge
19 Edge bead
20 Passenger aircraft
21 Aircraft floor
22 Opening in the aircraft floor
23 Passenger door

1. An aircraft galley comprising:
a main body;
the main body comprising at least walls and a cover plate which form a stowage space for catering containers and have a plurality of trolley berths that are next to one another;
the stowage space being configured as a cooling chamber;
at least one cooling apparatus configured to introduce cooling air into the stowage space via cooling air outlets in an upper region of the catering containers and to extract heated cooling air via return air inlets in a lower region of the catering containers; and
a drip pan disposed substantially perpendicularly below the cooling apparatus, the drip pan comprising, in an edge region of at least one side, a transition portion to a seal, and a collecting portion.

2. The aircraft galley according to claim 1, wherein a further edge region of the drip pan is configured as a floor boundary portion.

3. The aircraft galley according to claim 1, wherein the collecting portion comprises a circumferential edge bead.

4. The aircraft galley according to claim 1, wherein the drip pan has an outflow opening.

5. The aircraft galley according to claim 4, wherein an outflow hose with a connector to an aircraft drainage system is at the outflow opening.

6. The aircraft galley according to claim 5, wherein the outflow hose is configured to be guided through a floor panel of the aircraft floor.

7. The aircraft galley according to claim 1, wherein the cooling apparatus, the cooling air outlets and return air inlets are in a region of a rear wall.

8. The aircraft galley according to claim 1, wherein a width of the drip pan corresponds substantially to a width of a trolley berth.

9. The aircraft galley according to claim 1, wherein a depth of the drip pan results from floor clearance between a rearward wall of the stowage space and rear wheels of the catering container.

10. The aircraft galley according to claim 1, wherein the seal is in a region of the aircraft floor via bars on the walls of the galley.

11. A passenger aircraft comprising an aircraft galley, the aircraft galley comprising:
a main body;
the main body comprising at least walls and a cover plate which form a stowage space for catering containers and have a plurality of trolley berths that are next to one another;
the stowage space being configured as a cooling chamber;
at least one cooling apparatus configured to introduce cooling air into the stowage space via cooling air outlets in an upper region of the catering containers and to extract heated cooling air via return air inlets in a lower region of the catering containers; and
a drip pan disposed substantially perpendicularly below the cooling apparatus, the drip pan comprising, in an edge region of at least one side, a transition portion to a seal, and a collecting portion.
